(19) United States
(12) Patent Application Publication
(10) Pub. No.: US 2021/0010506 A1
(43) Pub. Date: Jan. 14, 2021

(54) CONNECTION STRUCTURE OF EXTERNAL THREAD OF ASYMMETRIC BIDIRECTIONAL TAPERED THREAD IN OLIVE-LIKE SHAPE AND TRADITIONAL SCREW THREAD

(71) Applicant: AMICUS VERITATIS MACHINERY CO., LTD., TAIZHOU (CN)

(72) Inventor: Yihua YOU, TAIZHOU (CN)

(21) Appl. No.: 17/035,995

(22) Filed: Sep. 29, 2020

Related U.S. Application Data
(63) Continuation of application No. PCT/CN2019/081386, filed on Apr. 4, 2019.

(30) Foreign Application Priority Data
Apr. 7, 2018 (CN) 201810303093.3

(51) Int. Cl. F16B 33/02

(52) U.S. Cl. CPC F16B 33/02

(57) ABSTRACT

The present invention belongs to the field of general technology of device, and particularly relates to a connection structure of an external thread of an asymmetrical bidirectional tapered thread in an olive-like shape and a traditional screw thread, which solves the problems such as poor self-positioning and self-locking performance of the existing screw thread. The connection structure is characterized in that an external thread (9) is in a helical form on an external surface of a columnar body (3); and a complete unit thread is a bidirectional truncated cone body (71) (material entity) in an olive-like shape (93) in which a left taper (95) is greater than and/or less than a right taper (96). The external thread (9) is capable of assimilating a traditional internal thread (6).

### CROSS-REFERENCE TO RELATED APPLICATIONS

This application is a continuation of International Patent Application No. PCT/CN2019/081386, filed on Apr. 4, 2019, entitled “Connection Structure of External Thread of Asymmetrical Tapered Thread and Traditional Screw Thread” which claims priority to China Patent Application No. 201810303093.3, filed on Apr. 7, 2018. The contents of these identified applications are hereby incorporated by references.

### TECHNICAL FIELD

The present invention belongs to the field of general technology of device, and particularly relates to a connection structure of an external thread of an asymmetrical bidirectional tapered thread in an olive-like shape and a traditional screw thread (hereinafter referred to as “a connection structure of a bidirectional tapered external thread and a traditional screw thread”).

### BACKGROUND OF THE INVENTION

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same tooth profile and continuously protruding along a helical line on a cylindrical or conical surface; and the “tooth body” refers to a material entity between adjacent flanks. This is also the definition of thread under global consensus.

The modern thread began in 1841 with British Whitworth thread. According to theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, The put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder, and the flatter the inclined plane is, the greater the mechanical advantage is (see FIG. 8) (Jingshan Yang and Xiuya Wang, Discussion on the Principle of Screws, Disquisitiones Arithmeticae of Gauss).

The “principle of inclined plane” of the modern thread is an inclined plane slider model (see FIG. 9) which is established based on the law of inclined plane. It is believed that the thread pair meets the requirements of self-locking when a thread rise angle is less than or equal to the equivalent friction angle under the condition of little change of static load and temperature. The thread rise angle (see FIG. 10), also known as a thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of teeth of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF THE INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide a connection structure of a bidirectional tapered external thread and a traditional screw thread with reasonable design, simple structure, and excellent connection performance and locking performance with respect to the above problems.

To achieve the above object, the following technical solution is adopted in the present invention: the connection structure of the bidirectional tapered external thread and the traditional screw thread is a special thread pair technology combining technical characteristics of a cone pair and a helical movement, and includes an external thread of an asymmetrical bidirectional tapered thread and an internal thread of a traditional screw thread. The external thread of the bidirectional tapered thread is a helical technology for combining technical characteristics of a bidirectional tapered body and a helical structure. The bidirectional tapered body is composed of two single tapered bodies, that is, is bidirectionally composed of two single tapered bodies with opposite directions and different sizes in a left taper and a right taper. The bidirectional tapered body is helically distributed on the external surface of a columnar body to form the external thread. A complete unit thread of the external thread is a special asymmetric bidirectional helical tapered geometry with a large middle and two small ends, including two structure forms in which the left taper is greater than the right taper and/or the left taper is less than the right taper.

In the connection structure of the bidirectional tapered external thread and the traditional screw thread, the asymmetric bidirectional tapered external thread in the olive-like shape includes two structure forms in which the left taper is greater than the right taper and the left taper is less than the right taper. The definition of the asymmetric bidirectional tapered external thread can be expressed as “a special helical bidirectional tapered geometry with a large middle and two small ends, which has asymmetric bidirectional truncated cone bodies with the specified left and right tapers opposite in direction and different in size, and the asymmetrical bidirectional truncated cone bodies are continuously and/or discontinuously distributed along the helical line”. The head or the tail of the asymmetric bidirectional tapered thread may be an uncompleted bidirectional tapered geometry due to manufacturing and other reasons. Different from the modern thread technology, the thread technology has changed from the cohesion relationship between the internal thread and the external thread in the modern thread to the cohesion relationship between the internal thread and the external thread in the bidirectional tapered thread.

The connection structure of the bidirectional tapered external thread and the traditional screw thread includes a bidirectional truncated cone body helically distributed on an external surface of a columnar body, that is, an external thread and an internal thread which are in mutual thread fit. The internal thread is a special helical bidirectional tapered hole and exists in the form of a “non-entity space”; and the external thread is a helical bidirectional truncated cone body and exists in the form of a “material entity”. The non-entity space refers to a space environment capable of accommodating the above material entity. The internal thread is a housing member, and the external thread is a housed member. The threads work in such a state that a special tapered hole formed by making the traditional internal thread be in contact with the bidirectional tapered external thread houses and is fitted with the bidirectional tapered external thread, that is, the bidirectional truncated cone body, pitch by pitch, and the internal thread and the external thread are fitted together by screwing the two bidirectional tapered geometries pitch by pitch, and the internal thread is cohered with the external thread till one side bears the load bidirectionally or both the left side and the right side bear the load bidirectionally at the same time or till the external thread and the internal thread are in interference fit. Whether the two sides bear bidirectional load at the same time is related to the actual working conditions in the application field, that is, the bidirectional tapered hole houses and is fitted with the bidirectional truncated cone body pitch by pitch, i.e., the internal thread is fitted with the corresponding external thread pitch by pitch.

The thread connection pair is a thread pair formed by fitting a helical external conical surface with a helical internal conical surface to form a cone pair. The external conical surface of the external cone body of the bidirectional tapered thread is a bidirectional conical surface. When the bidirectional tapered external thread and the traditional internal thread form the thread connection pair, a joint surface between the internal conical surface of the traditional internal thread and the external conical surface of the bidirectional tapered external thread is used as a bearing surface. Namely, the conical surface is used as the bearing surface to realize the technical performance of connection. The self-locking, self-positioning, reusability, fatigue resistance and other capabilities of the thread pair mainly depend on the conical surfaces and of the taper size of the truncated cone body of the bidirectional tapered external thread forming the connection structure of the bidirectional tapered external thread and the traditional screw thread as well as the special conical surface and the taper size of the special tapered hole formed by making the internal thread of the traditional screw thread be in contact with the bidirectional tapered external thread. The thread pair is a non-toothed thread.

Different from that the principle of inclined plane of the existing thread which shows a unidirectional force distributed on the inclined plane as well as an cohesion relationship between the internal tooth bodies and the external tooth bodies of the internal thread and the external thread, the external thread body, that is, the bidirectional tapered body, of the connection structure of the bidirectional tapered external thread and the traditional screw thread is composed of two plain lines of the cone body in two directions (i.e. bidirectional state) when viewed from any cross section of the single tapered body distributed on either left or right side along the cone axis. The plain line is the intersection line of the conical surfaces and a plane through which the cone axis passes through. The cone principle of the connection structure of the bidirectional tapered external thread and the traditional screw thread shows an axial force and a counter-axial force, both of which are combined by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone body) is cohered with the corresponding tapered cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair, composed of the internal thread and the external thread in the traditional thread, which realizes its connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the internal conical surface of the internal cone body is cohered with the external conical surface of the external cone body; and the internal conical surface is in close contact with the external conical surface. The axial force of the internal cone and the counter-axial force of the external cone are concepts of forces unique to the bidirectional tapered thread technology, i.e., the cone pair technology, in the present invention.

The internal cone body exists in a form similar to a shaft sleeve, and generates the axial force pointing to or pressing toward the cone axis under the action of an external load. The axial force is bidirectionally combined by a pair of centripetal forces which are distributed in mirror image with the cone axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and/or approximately reversely collinear when the cone body and the helical structure are combined into the thread and form the thread pair. The internal cone and the external cone are cohered till interference is achieved, so the axial force and the counter-axial force generate a pressure on the contact surface between the internal conical surface and the external conical surface and are densely and uniformly distributed on the contact surface between the internal conical surface and the external conical surface axially and circumferentially. When the cohesion movement of the internal cone and the external cone continues till the cone pair reaches the pressure generated by interference fit to combine the internal cone with the external cone, i.e., the pressure enables the internal cone body to be cohered with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. However, not any axial force angle and/or counter-axial force angle may enable the cone pair to produce self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation until the cone pair completely has no self-locking ability; and the axial bearing capacity changes in a direction of enhancement until the axial bearing capacity is the strongest.

When the axial force angle and/or the counter-axial force angle is less than 180° and greater than 127, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127 and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation until the cone pair is close to have has no self-positioning ability at all.

Compared with the technology with the housing and housed relationship of irreversible one-sided bidirectional housing that the unidirectional tapered thread of a single cone body invented by the applicant before which can only bear the load by one side of the conical surface, the thread connection pair of the bidirectional tapered thread technology of the present disclosure allows the reversible left and right-sided bidirectional housing of the bidirectional tapered threads of double cone bodies, enabling the left side and/or the right side of the conical surface to bear the load, and/or the left conical surface and the right conical surface to respectively bear the load, and/or the left conical surface and the right conical surface to simultaneously bear the load bidirectionally, and further limiting a disordered degree of freedom between the tapered hole and the truncated cone body; and the helical movement enables the thread connection pair to obtain a necessary ordered degree of freedom, thereby effectively combining the technical characteristics of the cone pair and the thread pair to form a brand-new thread technology.

When the connection structure of the bidirectional tapered external thread and the traditional screw thread is used in thread fit, the conical surface of the bidirectional truncated cone body of the external thread of the bidirectional tapered thread and the special conical surface of the bidirectional tapered hole of the traditional internal thread are fitted with each other.

According to the connection structure of the bidirectional tapered external thread and the traditional screw thread, self-locking and/or self-positioning of the thread connection pair is not realized at any taper or any taper angle of the bidirectional tapered external thread, i.e., the truncated cone body. The connection structure of the bidirectional tapered external thread and the traditional screw thread has the self-locking and self-positioning performances only when the external cone body reach a certain taper. The taper comprises the left taper and the right taper of the external thread body. The left taper corresponds to the left taper angle, that is, the first taper angle α1. The right taper corresponds to the right taper angle, that is, the second taper angle α2. When the left taper is greater than the right taper, preferably, the first taper angle α1 is greater than 0° and less than 53°, preferably, the first taper angle α1 takes a value in a range from 2° to 40°. For individual special fields, preferably, the first taper angle α1 is greater than or equal to 53° and less than 180°, preferably, the first taper angle α1 takes a value in a range from 53° to 90°; and preferably, the second taper angle α2 is greater than 0° and less than 53°, preferably, the second taper angle α2 takes a value in a range from 2° to 40°.

When the right taper is greater than the left taper, preferably, the first taper angle α1 is greater than 0° and less than 53°, preferably, the first taper angle α1 takes a value in a range from 2° to 40°; and preferably, the second taper angle α2 is greater than 0° and less than 53°, preferably, the second taper angle α2 takes a value in a range from 2° to 40°. For individual special fields, preferably, the second taper angle α2 is greater than or equal to 53° and less than 180°, preferably, the second taper angle α2 takes a value in a range from 53° to 90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

The external thread of the connection structure of the bidirectional tapered external thread and the traditional screw thread is arranged on the external surface of the columnar body, wherein a screw body is arranged on the columnar body; the truncated cone body is helically distributed on the external surface of the screw body, including a bidirectional truncated cone body. The truncated cone body includes a bidirectional truncated cone body. The columnar body may be solid or hollow, including cylindrical and/or non-cylindrical workpieces and objects that need to be machined with threads on external surfaces thereof, wherein the external surfaces include cylindrical surfaces, non-cylindrical surfaces such as conical surfaces, and external surfaces of other geometric shapes.

According to the connection structure of the bidirectional tapered external thread and the traditional screw thread, the asymmetric bidirectional truncated cone body, i.e., the external thread, is formed by symmetrically and oppositely lower bottom surfaces of two truncated cone bodies with the same lower bottom surfaces, and upper top surfaces are disposed on two ends of the bidirectional truncated cone body to form the asymmetric bidirectional tapered thread in an olive-like shape, and the process includes that the upper top surface are respectively fitted with upper top surfaces of adjacent bidirectional tapered holes and/or respectively fitted with upper top surfaces of adjacent bidirectional tapered holes in a helical shape. The external thread comprises a first helical conical surface of the truncated cone body, a second helical conical surface of the truncated cone body and an external helical line. Within a cross section through which the thread axis passes, a complete single-pitch asymmetric bidirectional tapered external thread is a special bidirectional tapered geometry in the olive-like shape, with a large middle and two small ends. The asymmetric bidirectional truncated cone body includes conical surfaces of the bidirectional truncated cone body. The included angle formed between the two plain lines of the left conical surface of the first helical conical surface of the truncated cone body, is the first taper angle α1. The first helical conical surface of the truncated cone body forms the left taper and is in a leftward distribution. An included angle between two plain lines of a right conical surface, that is, the second helical conical surface of the truncated cone body, is a second taper angle α2. The second helical conical surface of the truncated cone body forms the right taper and is in a rightward distribution. The taper directions corresponding to the first taper angle and the second taper angle are opposite. The plain line is an intersection line of the conical surface and the plane through which the cone axis passes. A shape formed by the first helical conical surface and the second helical conical surface of the truncated cone body of the bidirectional truncated cone body is the same as a shape of an external helical lateral surface of a rotary body, wherein the rotary body is formed by two inclined sides of a right-angled trapezoid union when the right-angled trapezoid union axially moves at a constant speed along a central axis of the columnar body while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and upper sides and same right-angled side and/or different right-angled sides, wherein the right-angled trapezoids coincide with the central axis of the columnar body. The right-angled trapezoid union refers to a special geometry, which is formed by symmetrically and oppositely jointing the lower bottom sides of two right-angled trapezoids with the same lower bottom sides and upper sides and same right-angled side and/or different right-angled sides and has the upper sides respectively located at both ends of the right-angled trapezoid union.

Due to the unique technical characteristic and advantage that a thread body of the bidirectional tapered external thread is a tapered body, that is, the truncated cone body, the bidirectional tapered external thread has higher capabilities of assimilative threads of different types, i.e., capabilities of assimilating traditional threads fitted with the threads into tapered threads of special forms having the same technical characteristics and properties. The traditional threads assimilated by the tapered threads are dissimilated traditional threads. It seems that, the appearance of the thread body is not much different from the traditional thread body. However, the bidirectional tapered external thread has no substantive technical content of the thread body of the traditional screw thread. The thread body is the special tapered geometry changing from the properties of the original traditional thread body to properties of a thread body having a tapered thread, that is, properties and technical characteristics of the tapered body. The special tapered geometry is radially provided with a special conical surface matched with the helical conical surface of the tapered thread. The above traditional threads include triangular threads, trapezoidal threads, sawtooth threads, rectangular threads, arc threads and other geometric threads that may be screwed with the bidirectional tapered thread so as to form the thread connection pair, but not limited to the above threads.

When the traditional internal thread is fitted with the bidirectional tapered external thread to form the thread connection pair, the traditional internal thread is not a traditional screw thread in the proper sense, but a special tapered thread assimilated by the tapered thread. A contact part of the traditional internal thread and the bidirectional tapered external thread forms an internal surface of the special tapered hole of the traditional internal thread of the thread connection pair that can be matched with a helical conical surface of the tapered thread. A special conical surface is formed on the special tapered geometry. With the increase of screwing use times, an effective conical surface area of the special conical surface on the special tapered hole of the traditional internal thread is continuously increased, that is, the special conical surface may be continuously enlarged and tends to have direction change of a larger contact surface with the helical conical surface of the truncated cone body of the bidirectional tapered external thread. Substantially, the special tapered hole that is incomplete in tapered geometry but has the technical spirit of the present invention is formed. Further, the special tapered hole is a thread body assimilated by the traditional internal thread due to cohered contact with the bidirectional tapered external thread, and is the special tapered geometry transformed from the tooth body of the traditional internal thread. The special tapered hole is radially provided with an internal surface that can be fitted with the conical surface, i.e., the special conical surface, of the bidirectional truncated cone body. The thread connection pair is formed as follows: the helical external conical surface, i.e., an external conical surface of the bidirectional tapered external thread, and the special helical internal conical surface, that is, a special conical surface of the special tapered hole formed from the traditional internal thread due to contact with the bidirectional tapered external thread are fitted with each other to form a cone pair so as to form the thread pair. The external conical surface, that is, an external conical surface of the external cone body, that is, the truncated cone body, is a bidirectional conical surface. The traditional screw thread assimilated by the tapered thread is a dissimilated traditional screw thread, and is a special tapered thread. The internal conical surface of the special tapered thread, that is, the special conical surface of the traditional internal thread appears in the form of lines. Moreover, with the increase of the contact use times of the crest of the traditional internal thread and the truncated cone body of the bidirectional tapered external thread, the internal conical surfaces are gradually increased. Namely, the special conical surface of the traditional internal thread is continuously changed and enlarged from microscopic surface (macroscopic line) to macroscopic surface; or an internal conical surface fitted with the bidirectional tapered external thread may be directly machined at the crest of the traditional internal thread. All the characteristics should be in accordance with the technical spirit of the present invention.

According to the connection structure of the bidirectional tapered external thread and the traditional screw thread, the internal thread is disposed on the internal surface of the cylindrical body to form the nut, wherein the cylindrical body is provided with a nut body, the internal surface of the nut body is provided with a helically distributed special tapered hole, the special tapered hole refers to a special tapered hole formed by making the traditional internal thread be in contact with the bidirectional tapered external thread, the special tapered hole is provided with a special conical surface, the cylindrical body includes cylindrical workpieces and objects and/or non-cylindrical workpieces and objects that need to be machined with screw threads on their internal surfaces, and the internal surfaces include columnar surfaces, non-columnar surfaces such as conical surfaces, and internal surfaces of other geometric shapes.

When the connection structure of the bidirectional tapered external thread and the traditional screw thread operates, the connection structure of the bidirectional tapered external thread and the traditional screw thread is in a relationship including a rigid connection and a non-rigid connection with a workpiece. The rigid connection means that a bearing surface of a nut and a bearing surface of the workpiece serve as bearing surfaces each other, and includes single-nut and double-nut structural forms. The non-rigid connection means that end surfaces at opposite sides of double nuts serve as bearing surfaces each other and/or the end surfaces of the opposite sides of the two nuts indirectly serve as bearing surfaces each other due to a gasket disposed therebetween. The non-rigid connection is mainly applied to a non-rigid material or a non-rigid connecting workpiece such as a transmission member or application fields in which demands are met by mounting the double nuts. The workpiece refers to a connected object including the workpiece, and the gasket refers to a spacer including the gasket.

According to the connection structure of the bidirectional tapered external thread and the traditional screw thread, when a connection structure of a bolt of a bidirectional tapered thread and double nuts of a traditional screw thread is adopted and is in a relationship of a rigid connection with a fastened workpiece, thread working bearing surfaces are different. When the cylindrical body is located at the left side of the fastened workpiece, that is, a left end surface of the fastened workpiece and a right end surface of the cylindrical body, that is, a left nut body, are locking bearing surfaces of the left nut body and the fastened workpiece, a right helical conical surface of the bidirectional tapered thread of the columnar body, that is, the bolt, is a tapered thread bearing surface, that is, the special conical surface of the traditional internal thread and a second helical conical surface of the truncated cone body of a bidirectional tapered external thread are bearing surfaces of the tapered thread, and the special conical surface of the traditional internal thread and the second helical conical surface of the truncated cone body serve as bearing surfaces each other. When the cylindrical body is located at the right side of the fastened workpiece, that is, a right end surface of the fastened workpiece and a left end surface of the cylindrical body, that is, a right nut body, are locking bearing surfaces of the right nut body and the fastened workpiece, a left helical conical surface of a bidirectional tapered thread of the columnar body, that is, the bolt, is a bearing surface of the tapered thread, that is, the special conical surface of the traditional internal thread and the first helical conical surface of the truncated cone body of the bidirectional tapered external thread are bearing surfaces of the tapered thread, and the special conical surface of the traditional internal thread and the first helical conical surface of the truncated cone body serve as bearing surfaces each other.

According to the connection structure of the bidirectional tapered external thread and the traditional screw thread, when a connection structure of a bolt of a bidirectional tapered thread and a single nut of a traditional screw thread is adopted and is in a relationship of a rigid connection with a fastened workpiece, and a hexagonal head of the bolt is located at the left side, the cylindrical body, that is, a nut body, that is, the single nut, is located at the right side of the fastened workpiece. When the connection structure of the bolt and the single nut operates, a right end surface of the workpiece and a left end surface of the nut body are locking bearing surfaces of the nut body and the fastened workpiece, and a left helical conical surface of a bidirectional tapered thread of the columnar body, that is, the bolt is a bearing surface of the tapered thread, that is, the special conical surface of the traditional internal thread and the first helical conical surface of the truncated cone body of the bidirectional tapered external thread are bearing surfaces of the tapered thread, and the special conical surface of the traditional internal thread and the first helical conical surface of the truncated cone body serve as bearing surfaces each other. When the hexagonal head of the bolt is located at the right side, the cylindrical body, that is, the nut body, that is, the single nut, is located at the left side of the fastened workpiece. When the connection structure of the bolt and the single nut operates, a left end surface of the workpiece and a right end surface of the nut body are locking bearing surfaces of the nut body and the fastened workpiece, and a right helical conical surface of the bidirectional tapered thread of the columnar body, that is, the bolt, is a bearing surface of the tapered thread, that is, the special conical surface of the traditional external thread and the second helical conical surface of the truncated cone body of the bidirectional tapered external thread are bearing surfaces of the tapered thread, and the special conical surface of the traditional internal thread and the second helical conical surface of the truncated cone body serve as bearing surfaces each other.

According to the connection structure of the bidirectional tapered external thread and the traditional screw thread, when the connection structure of the bolt of the bidirectional tapered thread and the double nuts of the traditional screw thread is adopted and is in a relationship of non-rigid connection with a fastened workpiece, bearing surfaces of the tapered thread are different. The cylindrical body includes a left nut body and a right nut body, and a right end surface of the left nut body and a left end surface of the right nut body are oppositely in direct contact and serve as locking bearing surfaces each other. When the right end surface of the left nut body is the locking bearing surface, a right helical conical surface of a bidirectional tapered thread of the columnar body, that is, the bolt, is a bearing surface of the tapered thread, that is, a special conical surface of a traditional internal thread and the second helical conical surface of the truncated cone body of the bidirectional tapered external thread are bearing surfaces of the tapered thread, and the special conical surface of the traditional internal thread and the second helical conical surface of the truncated cone body serve as bearing surfaces each other. When the left end surface of the right nut body is the locking bearing surface, a left helical conical surface of a bidirectional tapered thread of the columnar body, that is, the bolt is a bearing surface of the tapered thread, that is, the special conical surface of the traditional internal thread and the first helical conical surface of the truncated cone body of the bidirectional tapered external thread are bearing surfaces of the tapered thread, and the special conical surface of the traditional internal thread and the first helical conical surface of the truncated cone body serve as bearing surfaces each other.

According to the connection structure of the bidirectional tapered external thread and the traditional screw thread, when the connection structure of the bolt of the bidirectional tapered thread and the double nuts of the traditional screw thread is adopted and is in a relationship of a non-rigid connection with a fastened workpiece, bearing surfaces of the tapered thread are different. The cylindrical body includes a left nut body and a right nut body, a spacer such as a gasket is provided between the two cylindrical bodies, that is, the left nut body and the right nut body, and a right end surface of the left nut body and a left end surface of the right nut body are oppositely in indirect contact by the gasket so as to indirectly serve as locking bearing surfaces each other. When the cylindrical body is located at the left side, that is, the left side surface of the gasket, and the right end surface of the left nut body is the locking bearing surface of the left nut body, a right helical conical surface of a bidirectional tapered thread of the columnar body, that is, the bolt, is a tapered thread bearing surface, that is, a special conical surface of a traditional internal thread and the second helical conical surface of the truncated cone body of the bidirectional tapered external thread are tapered thread bearing surfaces, and the special conical surface of the traditional internal thread and the second helical conical surface of the truncated cone body serve as bearing surfaces each other. When the cylindrical body is located at the right side, that is, the right side surface of the gasket, and the left end surface of the right nut body is the locking bearing surface of the right nut body, a left helical conical surface of a bidirectional tapered thread of the columnar body, that is, the bolt, is a bearing surface of the tapered thread, that is, the special conical surface of the traditional internal thread and the first helical conical surface of the truncated cone body of the bidirectional tapered external thread are bearing surfaces of the tapered thread, and the special conical surface of the traditional internal thread and the first helical conical surface of the truncated cone body serve as bearing surfaces each other.

Further, when a cylindrical body located at the inner side, that is, a nut body adjacent to the fastened workpiece, has been effectively combined with a columnar body, that is, a screw body, that is, the bolt, i.e., an internal thread and an external thread forming a thread connection pair are effectively cohered together, a cylindrical body located at the outer side, that is, a nut body not adjacent to the fastened workpiece, may keep unchanged and/or may be removed with one nut being retained according to the application condition (such as application fields in which there are requirements on light weight of equipment or it is unnecessary to guarantee the reliability of a connection technology by double nuts), and the removed nut body is only used as a mounting process nut, rather than a connecting nut. An internal thread of the mounting process nut may be produced from the traditional screw thread which includes a triangular thread, a trapezoidal thread and a zigzagging thread and may be any applicable threads but is not limited to the above threads, and may further adopt a nut body produced from a bidirectional tapered thread and a unidirectional tapered thread capable of engaging with a screw thread of the bolt. On the premise that the reliability of a connection technology is guaranteed, the thread connection pair is a closed-loop fastening technical system, that is, after the internal thread and the external thread of the thread connection pair are effectively cohered together, the thread connection pair will form an independent technical system so as to be capable of guaranteeing the technical effectiveness of a connection technical system without depending on a third-party technology, that is, the effectiveness of the thread connection pair may not be affected even if there is no support from other objects, such a support includes that there is a gap between the thread connection pair and the fastened workpiece. In this way, the weight of the equipment will be greatly reduced, invalid loads will be removed, the technical demands of effective loading capacity, brake performance, energy saving and emission reduction on the equipment will be improved, which are thread technical advantages that are not provided by other thread technologies, but are only provided when the connection structure of the bidirectional tapered internal thread and the traditional screw thread is in a relationship of a non-rigid connection or a rigid connection with the fastened workpiece.

When the connection structure of the bidirectional tapered external thread and the traditional screw thread is in transmission connection, bidirectional load bearing is achieved by the screw connection of a special tapered hole of the traditional internal thread and the bidirectional truncated cone body. There must be a clearance between the bidirectional truncated cone body and the special tapered hole of the traditional internal thread. If there is oil and other mediums for lubrication between the internal thread and the external thread, it will easily form a load bearing oil film. The clearance is conducive to the formation of the load bearing oil film. The connection structure of the bidirectional tapered external thread and the traditional screw thread is applied in transmission connection, which is equivalent to a group of sliding bearing pairs composed of one pair and/or several pairs of sliding bearings, that is, each pitch of the traditional internal thread bidirectionally houses the corresponding pitch of the bidirectional tapered external thread to form a pair of sliding bearings, the number of the sliding bearings formed is adjusted according to the application conditions, that is, the number of the pitches of the housing screw threads and the housed screw threads for the effective bidirectional joint, that is, the effective bidirectional contact cohesion, of the traditional internal thread and the bidirectional tapered external thread is designed according to the application conditions. Through bidirectional housing of the special tapered hole of the traditional internal thread for the truncated cone body of the tapered external thread and positioning in multiple directions such as radial, axial, angular, and circumferential directions, preferably, through housing of the special tapered hole for the bidirectional truncated cone body and positioning of the internal cone and the external cone in multiple directions, which is formed by main positioning in radial and circumferential directions and auxiliary positioning in axial and angular directions until the special conical surface of the special tapered hole and a bidirectional conical surface of the truncated cone body are cohered to achieve the self-positioning or until the sizing interference contact to achieve the self-locking, a special composition technology of the cone pair and the thread pair is constituted, so as to ensure the transmission connection accuracy, efficiency and reliability of the tapered thread technology, especially the connection structure of the bidirectional tapered external thread and the traditional screw thread.

When the connection structure of the bidirectional tapered external thread and the traditional screw thread is in fastened and sealed connections, its technical performances are achieved by the screw connection of the special tapered hole of the traditional internal thread and the bidirectional truncated cone body of the tapered external thread, that is, the first helical conical surface of the truncated cone body and the special conical surface of the special tapered hole of the traditional internal thread are sized until the interference and/or the second helical conical surface of the truncated cone body and the special conical surface of the special tapered hole of the traditional internal thread are sized until the interference. Load bearing in one direction and/or in two directions simultaneously are/is achieved according to the application conditions, that is, the bidirectional truncated cone body and the special tapered hole of the traditional internal thread achieve that internal and external diameters of the internal cone of the special tapered hole of the traditional internal thread and the external cone of the tapered external thread are centralized under the guidance of the helical line until the special conical surface of the special tapered body of the traditional internal thread and the first helical conical surface of the truncated cone body are cohered until the interference contact and/or the special conical surface of the special tapered body of the traditional internal thread and the second helical conical surface of the truncated cone body are cohered until the interference contact, that is, through housing of the special tapered hole of the traditional internal thread for the bidirectional external cone of the tapered external thread for self-locking and positioning in multiple directions such as radial, axial, angular, and circumferential directions, preferably, through housing of the special tapered hole for the bidirectional truncated cone body and positioning of the internal cone and the external cone in multiple directions, which is formed by main positioning in radial and circumferential directions and auxiliary positioning in axial and angular directions until the special conical surface of the special tapered hole and the bidirectional conical surface of the truncated cone body are cohered to achieve the self-positioning or until the sizing interference contact to achieve the self-locking, a special composition technology of the cone pair and the thread pair is constituted, so as to ensure the efficiency and the reliability of the tapered thread technology, especially the connection structure of the bidirectional tapered external thread and the traditional screw thread, thereby realizing the technical performances such as connecting performance, locking capability, anti-loosening property, load bearing capability, fatigue resistance and sealing property of a mechanical structure.

Accordingly, the technical performances such as transmission accuracy and efficiency, load bearing capability, self-locking force, anti-loosening capability and sealing property of the connection structure of the bidirectional tapered external thread and the traditional screw thread are related to the first helical conical surface of the truncated cone body and the left taper (that is, the first taper angle α1) formed therefrom and the second helical conical surface of the truncated cone body and the right taper (that is, the second taper angle α2) formed therefrom as well as the special internal conical surface of the traditional internal thread that is formed by making the traditional internal thread be in contact with the external thread of the bidirectional tapered thread and the taper of the special internal conical surface. The friction coefficient, the processing quality and the application conditions of a material of which the columnar body and the cylindrical body are made have a certain influence on the cone fit.

According to the connection structure of the bidirectional tapered external thread and the traditional screw thread, when the right-angled trapezoid union rotates one revolution at a constant speed, an axial movement distance of the right-angled trapezoid union is at least double a length of the sum of the right-angled sides of the two right-angled trapezoids with the same lower bottom sides and the upper bottom sides and different right-angled sides. The structure ensures that the first helical conical surface and the second helical conical surface of the truncated cone body have sufficient length, thereby ensuring that the conical surface of the bidirectional truncated cone body and the special conical surface of the special tapered hole of the traditional internal thread have sufficient effective contact area and strength and the efficiency required by helical movement during fitting.

According to the connection structure of the bidirectional tapered external thread and the traditional screw thread, when the right-angled trapezoid union rotates one revolution at a constant speed, an axial movement distance of the right-angled trapezoid union is equal to a length of the sum of the right-angled sides of two right-angled trapezoids with the same lower bottom sides and the upper bottom sides and different right-angled sides. The structure ensures that the first helical conical surface and the second helical conical surface of the truncated cone body have sufficient length, thereby ensuring that the conical surface of the bidirectional truncated cone body and the special conical surface of the special tapered hole of the traditional internal thread have sufficient effective contact area and strength and the efficiency required by helical movement during fitting.

According to the connection structure of the bidirectional tapered external thread and the traditional screw thread, the first helical conical surface and the second helical conical surface of the truncated cone body are continuous helical surfaces or non-continuous helical surfaces.

According to the connection structure of the bidirectional tapered external thread and the traditional screw thread, the special conical surface of the special tapered hole is a continuous helical surface or a non-continuous helical surface.

According to the connection structure of the bidirectional tapered external thread and the traditional screw thread, one end and/or two ends of the columnar body may be one or two screwing ends screwed into a connecting hole of the cylindrical body. A thread connection function is achieved by making the special conical surface of the traditional internal thread and the first helical conical surface of the truncated cone body of the tapered external thread be in contact and/or interference fit and/or making the special conical surface of the traditional internal thread and the second helical conical surface of the truncated cone body of the tapered external thread be in contact and/or interference fit.

In the above-mentioned connection structure of the bidirectional tapered external thread and the traditional screw thread, a head a size of which is greater than the external diameter of the columnar body is disposed at one end of the columnar body and/or one head and/or two heads a size of which is less than a minor diameter of the bidirectional tapered external thread of the screw body of the columnar body are/is disposed at one end and/or two ends of the columnar body, and the connecting hole is a threaded hole provided in a nut. That is, the columnar body and the head are connected as a bolt here, a stud has no head and/or has heads a size of which is less than the minor diameter of the bidirectional tapered external thread at two ends and/or has no screw thread in the middle and has two bidirectional tapered external threads respectively at two ends, and the connecting hole is disposed within the nut.

Compared with the prior art, the connection structure of the bidirectional tapered external thread and the traditional screw thread has the following advantages of reasonable design, simple structure, convenient operation, large locking force, large load bearing capability, good anti-loosening property, high transmission efficiency and accuracy, good mechanical sealing effect and good stability, may prevent the loosening from occurring during the connection, has self-locking and self-positioning functions, and achieves fastening and connecting functions by bidirectional load bearing or sizing of the cone pair that is formed by coaxial centralizing of the internal diameter and the external diameter of the internal cone and the external cone until the sizing interference fit.

### DESCRIPTION OF THE DRAWINGS

FIG. 1 is a schematic diagram showing a connection structure of a bolt of an asymmetric bidirectional tapered thread in an olive-like shape (in which a left taper is greater than a right taper) and double nuts of a traditional screw thread according to a first embodiment of the present invention.

FIG. 2 is a schematic diagram showing a structure of an external thread of an asymmetric bidirectional tapered thread in an olive-like shape (in which a left taper is greater than a right taper) and a complete unit thread thereof according to a first embodiment of the present invention.

FIG. 3 is a schematic diagram showing a connection structure of a bolt of an asymmetric bidirectional tapered thread in an olive-like shape (in which a left taper is greater than a right taper) and double nuts of a traditional screw thread according to a second embodiment of the present invention.

FIG. 4 is a schematic diagram showing a connection structure of a bolt of an asymmetric bidirectional tapered thread in an olive-like shape (in which a left taper is less than a right taper) and double nuts of a traditional screw thread according to a third embodiment of the present invention.

FIG. 5 is a schematic diagram showing a structure of an external thread of an asymmetric bidirectional tapered thread in an olive-like shape (in which a left taper is less than a right taper) and a complete unit thread thereof according to a third embodiment of the present invention.

FIG. 6 is a schematic diagram showing a connection structure of bolts of two asymmetric bidirectional tapered external threads in olive-like shapes including an asymmetric bidirectional tapered external thread in an olive-like shape (in which a left taper is less than a right taper) and an asymmetric bidirectional tapered external thread in an olive-like shape (in which a left taper is greater than a right taper) and double nuts of a traditional internal thread according to a fourth embodiment of the present invention.

FIG. 7 is a schematic diagram showing a structure of bolts of two asymmetric bidirectional tapered external threads in olive-like shapes including two taper structure forms of an asymmetric bidirectional tapered external thread in an olive-like shape (in which a left taper is less than a right taper) and an asymmetric bidirectional tapered external thread in an olive-like shape (in which a left taper is greater than a right taper) on a single screw body and a complete unit thread of an external thread according to a fourth embodiment of the present invention.

FIG. 8 is an illustration that “a screw thread in the existing screw thread technology is an inclined surface on a cylindrical surface or a conical surface” involved in the background art of the present invention.

FIG. 9 is an illustration of “an inclined surface slider model adopting a principle of the existing screw thread technology, that is, a principle of an inclined surface” involved in the background art of the present invention.

FIG. 10 is an illustration of “a thread lift angle in the existing screw thread technology” involved in the background art of the present invention.

In the figures, 1—tapered thread; 2—cylindrical body; 21—nut body; 22—nut body; 3—columnar body; 31—screw body; 4—special tapered hole; 42—special conical surface; 6—internal thread; 7—truncated cone body; 71—bidirectional truncated cone body; 72—conical surface of bidirectional truncated cone body; 721—first helical conical surface of truncated cone body, α1—first taper angle; 722—second helical conical surface of truncated cone body; α2—second taper angle; 8—external helical line; 9—external thread; 93—olive-like shape; 95—left taper, 96—right taper, 97—leftward distribution; 98—rightward distribution; 10—thread connection pair and/or thread pair, 101—clearance; 111—locking bearing surface; 112—locking bearing surface; 122—bearing surface of tapered thread; 121—bearing surface of tapered thread; 130—workpiece; 20—polish rod; 01—cone axis; 02—thread axis; A—slider on inclined surface body; B—inclined surface body; G—gravity; G—gravity component along inclined surface; F—friction force; q—thread lift angle; P—equivalent friction angle; d—major diameter of traditional external thread; d1—minor diameter of traditional external thread; and d2—pitch diameter of traditional external thread.

### DETAILED DESCRIPTION OF PREFERRED EMBODIMENTS

The present invention will be further described in detail below with reference to the accompany drawings and specific embodiments.

### A First Embodiment

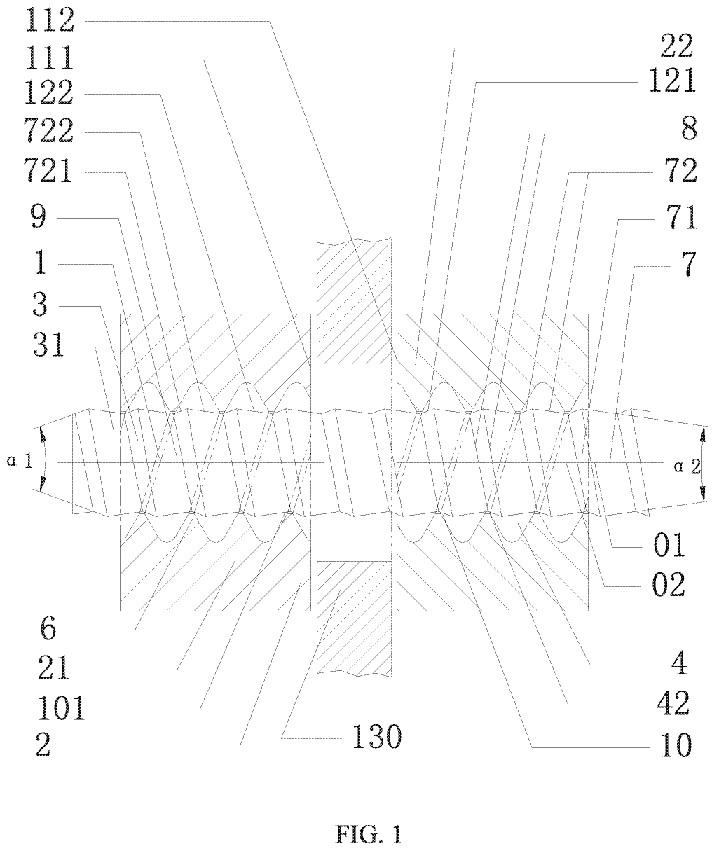

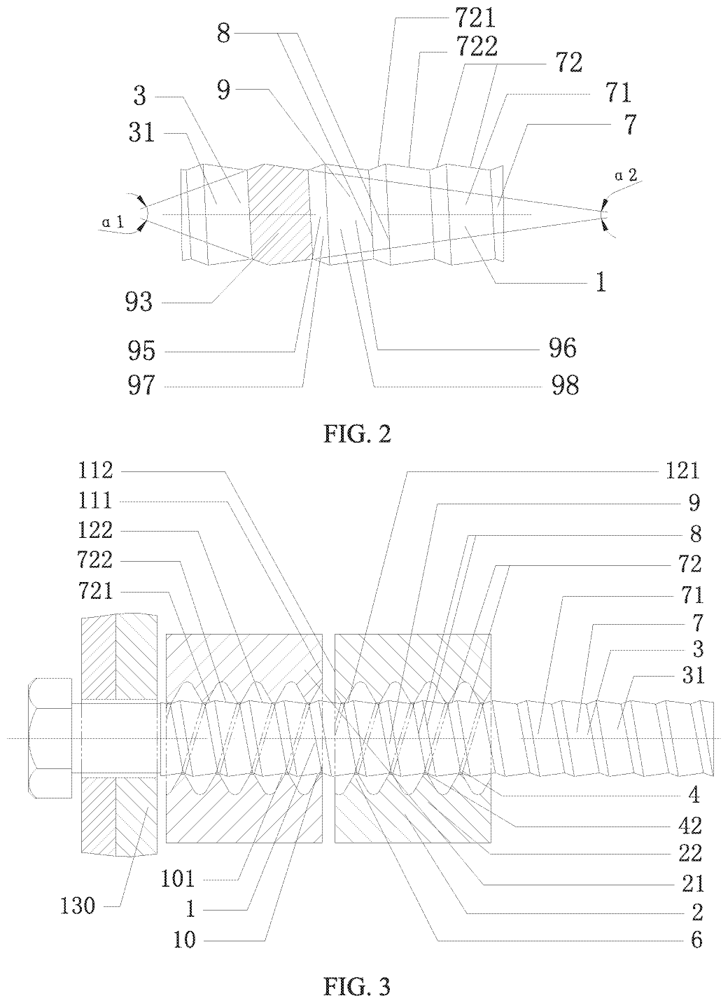

As shown in FIG. 1 and FIG. 2, the present embodiment provides a connection structure of an asymmetric bidirectional tapered external thread 9 and a traditional internal thread 6. The connection pair 10 of the bidirectional tapered external thread and the traditional screw thread includes a bidirectional truncated cone body 71 helically distributed on the external surface of a columnar body 3 and a special tapered hole 4 which is formed by making the traditional internal thread 6 be in contact with the external thread 9 of the bidirectional tapered thread and helically distributed on the internal surface of the cylindrical body 2, that is, the external thread 9 and the internal thread 6 in mutual thread fit. The internal thread 6 is provided with a special helical tapered hole 4, and the external thread 9 is provided with a helical bidirectional truncated body 71. The internal thread 6 exists in the form of the special helical tapered hole 4 and a “non-entity space”, and the external thread 9 exists in the form of the helical bidirectional truncated cone body 7 and a “material entity”. The internal thread 6 and the external thread 9 are subjected to a relationship of a housing member and a housed member as follows: the internal thread 6 and the external thread 9 are fitted together by screwing bidirectional tapered geometries pitch by pitch and cohered till an interference fit is achieved, i.e., the special tapered hole 4 formed by making the traditional internal thread 6 be in contact with the bidirectional tapered external thread 9 houses the bidirectional truncated cone body 71 pitch by pitch, that is, the internal thread 6 houses the external thread 9 pitch by pitch. The bidirectional housing limits a disordered degree of freedom between the special tapered hole 4 and the truncated cone body 7 of the traditional internal thread 6; and the helical movement enables the connection pair 10 of the bidirectional tapered external thread and the traditional screw thread to obtain a necessary ordered degree of freedom. Accordingly, technical characteristics of the cone pair and the thread pair are effectively combined.

When the connection pair 10 of the bidirectional tapered external thread and the traditional screw thread is used, a conical surface 72 of the bidirectional truncated cone body and the special conical surface 42 of the special tapered hole 4 of the traditional internal thread 6 are fitted with each other.

The connection pair 10 of the bidirectional tapered external thread and the traditional screw thread in the present embodiment has the self-locking and self-positioning performances only if the truncated cone body 7, that is, the cone body, reaches a certain taper angle. The taper comprises a left taper 95 and a right taper 96. In asymmetrical bidirectional tapered thread 1 of the present embodiment, the left taper 95 is greater than the right taper 96 The left taper 95 corresponds to the left taper angle, i.e., a first taper angle α1. It is preferable that the first taper angle α1 is greater than 0° and smaller than 53°; and preferably, the first taper angle α1 takes a value in a range from 2° to 40°. The right taper 96 corresponds to the right taper angle, i.e., a second taper angle α2. It is preferable that the second taper angle α2 is greater than 0° and smaller than 53°; and preferably, the second taper angle α2 takes a value in a range from 2° to 40°.

The internal thread 6 is disposed on the internal surface of the cylindrical body 2, wherein the cylindrical body 2 includes a nut body 21 and a nut body 22, traditional internal threads 6 are disposed on the internal surfaces of the nut body 21 and the nut body 22, and the traditional internal threads 6 refer to other geometric threads, such as a triangular thread, a trapezoidal thread and a sawtooth thread, capable of engaging with the above-mentioned bidirectional tapered thread 1 to form the thread connection pair 10. When the traditional internal thread 6 is fitted with the bidirectional tapered external thread 9 to form the thread connection pair 10, the traditional internal thread 6 is not a traditional screw thread in the proper sense, but a special tapered thread 1. A contact part of the traditional internal thread and the bidirectional tapered external thread forms the special tapered hole 4 of the traditional internal thread 6 of the thread connection pair 10. A special conical surface 42 is formed on the special tapered hole 4. With the increase of screwing use times, an effective conical surface area of the special conical surface 42 on the special tapered hole 4 of the traditional internal thread 6 is continuously increased, that is, the special conical surface 42 may be continuously enlarged and tends to have a direction change of a larger contact surface with the conical surface of the bidirectional tapered external thread 9. Substantially, the special tapered hole 4 that is incomplete in tapered geometry but has the technical spirit of the present invention is formed. The internal conical surface, that is, a special conical surface 42 of the traditional internal thread 6, is a bidirectional conical surface appears in the form of lines. Moreover, with the increase of the contact use times of the crest of the traditional internal thread 6 and the truncated cone body 7 of the bidirectional tapered external thread 9, the internal conical surfaces are gradually increased. Namely, the special conical surface 42 of the traditional internal thread 6 is continuously changed and enlarged from a line to a surface; or an internal conical surface fitted with the bidirectional tapered external thread 9 may be directly machined at the crest of the traditional internal thread 6. All the characteristics should be in accordance with the technical spirit of the present invention. The cylindrical body 2 includes cylindrical workpieces and objects and/or non-cylindrical workpieces and objects that need to be machined with internal threads on their internal surfaces.

The external thread 9 is arranged on the external surface of the columnar body 3, wherein the columnar body 3 is provided with a screw body 31; the truncated cone body 7 is helically distributed on the external surface of the screw body 31; and the truncated cone body 7 includes the bidirectional truncated cone body 71. The columnar body 3 may be solid or hollow, and includes cylindrical workpieces and objects, conical workpieces and objects, and tubular workpieces and objects that need to be machined with external threads on their external surfaces.

The asymmetric bidirectional truncated cone body 71 in the olive-like shape 93 is formed by symmetrically and oppositely jointing lower bottom surfaces of two truncated cone bodies with the same lower bottom surfaces and the same upper top surfaces but different cone heights. The upper top surfaces are located at both ends of the bidirectional truncated cone body 71 to form the bidirectional tapered thread 1, the process includes that the upper top surfaces are respectively jointed with the upper top surfaces of the adjacent bidirectional truncated cone bodies 71 and/or respectively jointed with the upper top surfaces of the adjacent bidirectional truncated cone bodies 71. The external thread 9 includes a first helical conical surface 721 of the truncated cone body, a second helical conical surface 722 of the truncated cone body and an external helical line 8. Within a cross section passing through the thread axis 02, a complete single-pitch symmetric bidirectional tapered external thread 9 is a special bidirectional tapered geometry in the olive-like shape 93 and with a large middle and two small ends and in which the taper of the left tapered hole is greater than that of the right taper. The asymmetric bidirectional truncated cone bodies 71 include conical surfaces 72 of bidirectional truncated cone bodies. An included angle between two plain lines of the left conical surface of the asymmetric bidirectional truncated cone body 71, i.e., the first helical conical surface 721 of the truncated cone body, is the first taper angle α1. The first helical conical surface 721 of the truncated cone body forms the left taper 95 and is in a leftward distribution 97. An included angle between the two plain lines of the right conical surface of the asymmetric bidirectional truncated cone body 71, i.e., the second helical conical surface 722 of the truncated cone body, is the second taper angle α2. The second helical conical surface 722 of the truncated cone body corresponds to the right taper 96 and is in a rightward distribution 98. The taper directions corresponding to the first taper angle α1 and the second taper angle α2 are opposite. The plain line is an intersection line of the conical surface and the plane through which the cone axis 01 passes. A shape formed by the first helical conical surface of the truncated cone body and the second helical conical surface of the truncated cone body of the bidirectional truncated cone body is the same as a shape of an external helical lateral surface of a rotary body, wherein the rotary body is formed by two inclined sides of a right-angled trapezoid union when the right-angled trapezoid union axially moves at a constant speed along a central axis of the columnar body 3 while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the columnar body 3. The right-angled trapezoid union refers to a special geometry in which the lower bottom sides of the two right-angled trapezoids with the same lower bottom sides and the same upper bottom sides but different right-angled sides are symmetrically and oppositely joined and the upper bottom sides thereof are respectively located at two ends of the right-angled trapezoid union.

The connection structure of the bolt of the asymmetric bidirectional tapered external thread 9 and the double nuts of the traditional internal thread 6 is adopted in the present embodiment. A nut body 21 and a nut body 22 are respectively located at the left side and the right side of a fastened workpiece 130. During operation, the connection structure of the bolt and the double nuts is in a relationship of a rigid connection with the fastened workpiece 130. The rigid connection means that a bearing surface on the end surface of each nut and a bearing surface of the workpiece 130 serve as bearing surfaces each other, and the bearing surfaces include a locking bearing surface 111 and a locking bearing surface 112. The workpiece 130 refers to a connected object including the workpiece 130.

Thread working bearing surfaces in the present embodiment include a bearing surface 121 of the tapered thread and a bearing surface 122 of the tapered thread. When the left end surface of the fastened workpiece 130 and the right end surface of the left nut body 21 are the locking bearing surfaces 111 of the nut body 21 and the fastened workpiece 130, the right helical conical surface of the bidirectional tapered thread 1 of the columnar body 3, that is, the screw body 31, that is, the bolt, is the bearing surface of the tapered thread, that is, the special conical surface 42 of the traditional internal thread 6 and the second helical conical surface 722 of the truncated cone body of the tapered external thread 9 are bearing surfaces 122 of the tapered thread, and the special conical surface 42 of the traditional internal thread 6 and the second helical conical surface 722 of the truncated cone body serve as bearing surfaces each other. When the right end surface of the fastened workpiece 130 and the left end surface of the nut body 22 are the locking bearing surfaces 112 of the nut body 22 and the fastened workpiece 130, the left helical conical surface of the bidirectional tapered thread 1 of the e columnar body 3, that is, the screw body 31, that is, the bolt, is the bearing surface of the tapered thread, that is, the special conical surface 42 of the traditional internal thread 6 and the first helical conical surface 721 of the truncated cone body of the tapered external thread 9 are bearing surfaces 122 of the tapered thread, and the special conical surface 42 of the traditional internal thread 6 and the first helical conical surface 721 of the truncated cone body serve as bearing surfaces each other.

When the connection structure of the bidirectional tapered external thread and the traditional screw thread is in transmission connection, bidirectional load bearing is achieved by the screw connection of the special tapered hole 4 of the traditional internal thread 6 and the bidirectional truncated cone body 71. There must be a clearance 101 between the bidirectional truncated cone body 71 and the special tapered hole 4 of the traditional internal thread 6. The clearance 101 is conducive to the formation of a load bearing oil film. The thread connection pair 10 is equivalent to a group of sliding bearing pairs composed of one pair and/or several pairs of sliding bearings, that is, each pitch of the traditional internal thread 6 bidirectionally houses the corresponding pitch of the bidirectional tapered external thread 9 to form a pair of sliding bearings, the number of the sliding bearings formed is adjusted according to the application conditions, that is, the number of the pitches of the housing screw threads and the housed screw threads for the effective bidirectional joint, that is, the effective bidirectional contact cohesion, of the traditional internal thread 6 and the bidirectional tapered external thread 9 is designed according to the application conditions. Through bidirectional housing of the special tapered hole 4 for the bidirectional truncated cone body 7 and positioning in multiple directions such as radial, axial, angular, and circumferential directions, the transmission connecting accuracy, efficiency and reliability of the tapered thread technology, especially, the connection structure of the bidirectional tapered external thread and the traditional screw thread are ensured.

When the connection structure of the bidirectional tapered external thread and the traditional screw thread in the present embodiment is in fastened and sealed connections, technical performances are achieved by the screw connection of the special tapered hole 4 of the traditional internal thread 6 and the bidirectional truncated cone body 71, that is, the first helical conical surface 721 of the truncated cone body and the special conical surface 42 of the special tapered hole 4 of the traditional internal thread 6 are sized until the interference and/or the second helical conical surface 722 of the truncated cone body and the special conical surface 42 of the special tapered hole 4 of the traditional internal thread 6 are sized until the interference. Load bearing in one direction and/or in two directions simultaneously are/is achieved according to the application conditions, that is, the bidirectional truncated cone body 71 of the bidirectional tapered external thread 9 and the special tapered hole 4 of the traditional internal thread 6 achieve that internal and external diameters of the internal cone and the external cone are centralized under the guidance of the helical line until the special conical surface 42 of the special tapered hole 4 of the traditional internal thread 6 and the first helical conical surface 721 of the truncated cone body are cohered until the interference contact and/or the special conical surface 42 of the special tapered hole 4 of the traditional internal thread 6 and the second helical conical surface 722 of the truncated cone body are cohered until the interference contact, thereby achieving technical performances such as connecting performance, locking capability, anti-loosening property, load bearing capability, fatigue resistance and sealing property of a mechanical structure.

Accordingly, the technical performances such as transmission accuracy and efficiency, load bearing capability, self-locking force, anti-loosening capability, sealing performance and reusability of a mechanical structure of a connection pair 10 of the bidirectional tapered external thread and the traditional screw thread in the present embodiment are related to the first helical conical surface 721 of the truncated cone body and the left taper 95 (that is, the first taper angle α1) formed therefrom and the second helical conical surface 722 of the truncated cone body and the right taper 96 (that is, the second taper angle α2) formed therefrom as well as the special conical surface 42 of the special tapered hole 4 of the traditional internal thread 6 that is formed by making the traditional internal thread 6 be in contact with the bidirectional tapered external thread 9 and the taper of the special conical surface 42. The friction coefficient, the processing quality and the application conditions of a material of which the columnar body 3 and the cylindrical body 2 are made have a certain influence on the cone fit.

According to the connection structure of the bidirectional tapered external thread and the traditional screw thread, when the right-angled trapezoid union rotates one revolution at a constant speed, the axial movement distance of the right-angled trapezoid union is at least double the length of the sum of the right-angled sides of two right-angled trapezoids with the same lower bottom sides and the upper bottom sides but different right-angled sides. The structure ensures that the first helical conical surface 721 and the second helical conical surface 722 of the truncated cone body have sufficient length, thereby ensuring that the conical surface 72 of the bidirectional truncated cone body and the special conical surface 42 of the special tapered hole 4 of the traditional internal thread 6 have sufficient effective contact area and strength and the efficiency required by helical movement during fitting.

According to the connection structure of the bidirectional tapered external thread and the traditional screw thread, when the right-angled trapezoid union rotates one revolution at a constant speed, the axial movement distance of the right-angled trapezoid union is equal to the length of the sum of the right-angled sides of two right-angled trapezoids with the same bottom sides and the same upper bottom sides but different right-angled sides. The structure ensures that the first helical conical surface 721 and the second helical conical surface 722 of the truncated cone body have sufficient length, thereby ensuring that the conical surface 72 of the bidirectional truncated cone body and the special conical surface 42 of the special tapered hole 4 of the traditional internal thread 6 have sufficient effective contact area and strength and the efficiency required by helical movement during fitting.

According to the connection structure of the bidirectional tapered external thread and the traditional screw thread, the first helical conical surface 721 of the truncated cone body and the second helical conical surface 722 of the truncated cone body are both continuous helical surfaces or non-continuous helical surfaces.

According to the connection structure of the bidirectional tapered external thread and the traditional screw thread, one end and/or two ends of the columnar body 3 may be one or two screwing ends screwed into a connecting hole of the cylindrical body 2. A connecting hole is a threaded hole provided in the nut body 21. A head a size of which is greater than an external diameter of the columnar body 3 is arranged at one end of the columnar body 3, and/or one head and/or two heads a size of which is smaller than a minor diameter of the external thread 9 of the screw body 31 of the columnar body 3 is/are arranged at one end and/or two ends of the columnar body 3. That is, the columnar body 3 and the head are connected as the bolt here, and a stud has no head and/or has heads a size of which is less than the minor diameter of the bidirectional tapered external thread 9 at two ends and/or has no screw thread in the middle and has a bidirectional tapered external thread 9 respectively at two ends.

Compared with the prior art, the connection pair 10 of the bidirectional tapered external thread and the traditional screw thread has the advantages of reasonable design, simple structure, convenient operation, large locking force, large load bearing capability, good anti-loosening property, high transmission efficiency and accuracy, good mechanical sealing effect and good stability, may prevent the loosening from occurring during the connection, has self-locking and self-positioning functions, and achieves fastening and connecting functions by sizing the diameter of the cone pair formed by the internal cone and the external cone until the interference fit.

### A Second Embodiment

As shown in FIG. 3, the structure, principle and implementation steps of the present embodiment are similar to those of the first embodiment, except that there are different position relationships between double nuts and a fastened workpiece 130. The double nuts include a nut body 21 and a nut body 22, and a bolt body is provided with a hexagonal head larger than a screw body 31. When the hexagonal head of the bolt is located at the left side, the nut body 21 and the nut body 22 both are located at the right side of the fastened workpiece 130. When the bolt and the double nuts in the present embodiment operate, the nut body 21, the nut body 22 and the fastened workpiece 130 are in a relationship of a non-rigid connection. The non-rigid connection means that end surfaces opposite to end surfaces of the two nuts, that is, the nut body 21 and the nut body 22, serve as bearing surfaces each other, and the bearing surfaces include the locking bearing surface 111 and the locking bearing surface 112. The non-rigid connection is mainly applied to a non-rigid material or a non-rigid connecting workpiece 130 such as a transmission member or application fields in which demands are met by mounting the double nuts. The workpiece 130 refers to a connected object including the workpiece 130.

The thread working bearing surfaces in the present embodiment include the bearing surface 121 of the tapered thread and the bearing surface 122 of the tapered thread, that is, include a nut body 21 and a nut body 2. The right end surface, that is, the locking bearing surface 111, of the nut body 21 and the left end surface, that is, the locking bearing surface 112, of the nut body 22 are oppositely in direct contact and are locking bearing surfaces each other. When the right end surface of the nut body 21 is the locking bearing surface 111, the right helical conical surface of the bidirectional tapered thread 1 of the columnar body 3, that is, the screw body 31, that is, the bolt, is a bearing surface 122 of the tapered thread, that is, the special conical surface 42 of the traditional internal thread 6 and the second helical conical surface 722 of the truncated cone body of the tapered external thread 9 are bearing surfaces 122 of the tapered thread and the special conical surface 42 of the traditional internal thread 6 and the second helical conical surface 722 of the truncated cone body are bearing surfaces each other. When the left end surface of the nut body 22 is the locking bearing surface 112, the left helical conical surface of the bidirectional tapered thread 1 of the columnar body 3, that is, the screw body 31, that is, the bolt, is a bearing surface 121 of the tapered thread, that is, the special conical surface 42 of the traditional internal thread 6 and the first helical conical surface 721 of the truncated cone body of the tapered external thread 9 are bearing surfaces 121 of the tapered thread and the special conical surface 42 of the traditional internal thread 6 and the first helical conical surface 721 of the truncated cone body are bearing surfaces each other.

In the present embodiment, when the cylindrical body 2 located at the inner side, that is, the nut body 21 adjacent to the fastened workpiece 130, has been effectively combined with a columnar body 3, that is, the screw body 31, that is, the bolt, i.e., an internal thread 6 and an external thread 9 forming a tapered thread connection pair 10 are effectively cohered together. A cylindrical body 2 located at the outer side, that is, the nut body 22 not adjacent to the fastened workpiece 130, may keep unchanged and/or may be removed with one nut being retained according to the application condition (such as application fields in which there are requirements on light weight of equipment or it is unnecessary for double nuts to guarantee the reliability of a connection technology), and the removed nut body 22 is only used as a mounting process nut, rather than a connecting nut. An internal thread of the mounting process nut may be produced from the traditional screw thread and may further adopt the nut body 22 produced from a bidirectional tapered thread 1 and a unidirectional tapered thread capable of engaging with the screw thread of the bolt. On the premise that the reliability of the connection technology is guaranteed, the thread connection pair 10 is a closed-loop fastening technical system, that is, after the internal thread 6 and the external thread 9 of the thread connection pair 10 are effectively cohered together, the thread connection pair 10 will form an independent technical system so as to be capable of guaranteeing the technical effectiveness of a connection technical system without depending on a third-party technology, that is, the effectiveness of the thread connection pair 10 may not be affected even if there is no support from other objects, such a support includes that there is a gap between the thread connection pair 10 and the fastened workpiece 130. In this way, the weight of the equipment will be greatly reduced, invalid loads will be removed, the technical demands of effective loading capacity, brake performance, energy saving and emission reduction on the equipment will be improved, which are thread technical advantages that are not provided by other thread technologies, but are only provided when the thread connection pair 10 of the connection structure of the bidirectional tapered external thread and the traditional screw thread is in a relationship of a non-rigid connection or a rigid connection with the fastened workpiece 130.

In the present embodiment, when the hexagonal head of the bolt is located at the right side, the nut body 21 and the nut body 22 are both located at the left side of the fastened workpiece 130, and the structure, principle and implementation steps of the hexagonal head of the bolt are similar to those of the present embodiment.

### A Third Embodiment

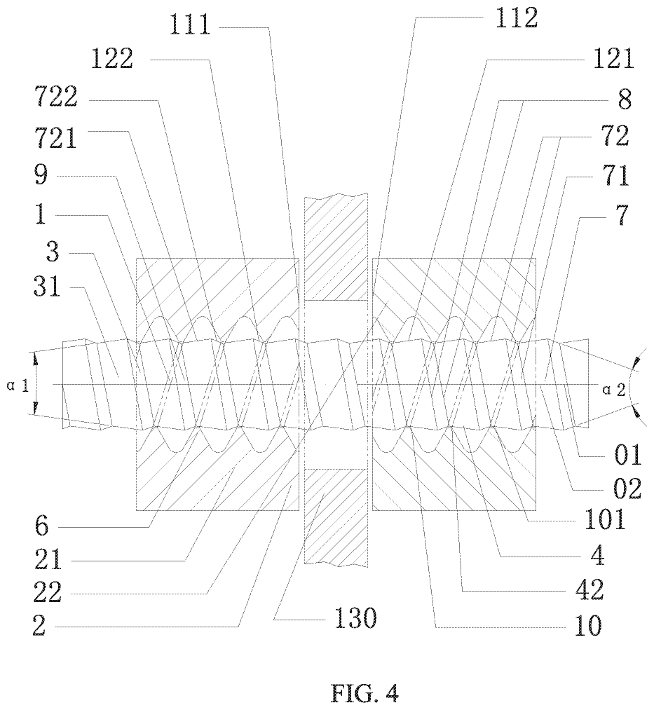

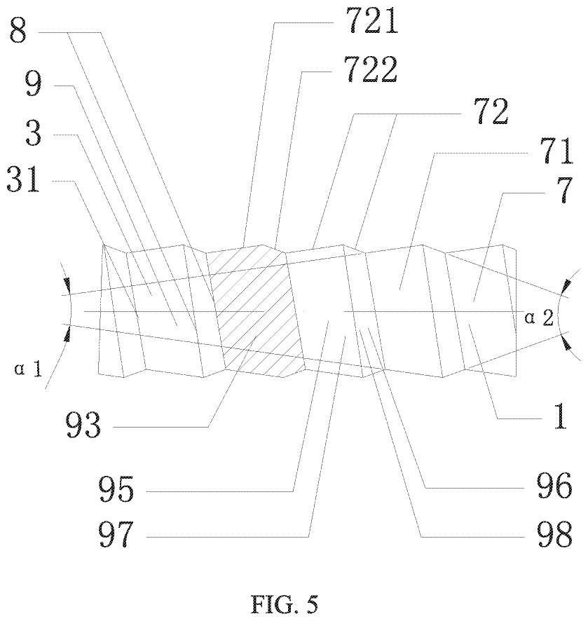

As shown in FIG. 4 and FIG. 5, the structure, principle and implementation steps of the present embodiment are similar to those of the first embodiment, except that, the asymmetric bidirectional tapered thread 1 in the present embodiment has a left taper 95 less than a right taper 96, preferably, a first taper angle α1 is greater than 0° and less than 53°, preferably, the first taper angle α1 takes a value in a range from 2° to 40°; and preferably, a second taper angle α2 is greater than 0° and less than 53°, preferably, the second taper angle α2 takes a value in a range from 2° to 40°. For individual special fields, preferably, the second taper angle α2 is greater than or equal to 53° and less than 180°, preferably, the second taper angle α2 takes a value in a range from 53° to 90°.

### A Fourth Embodiment

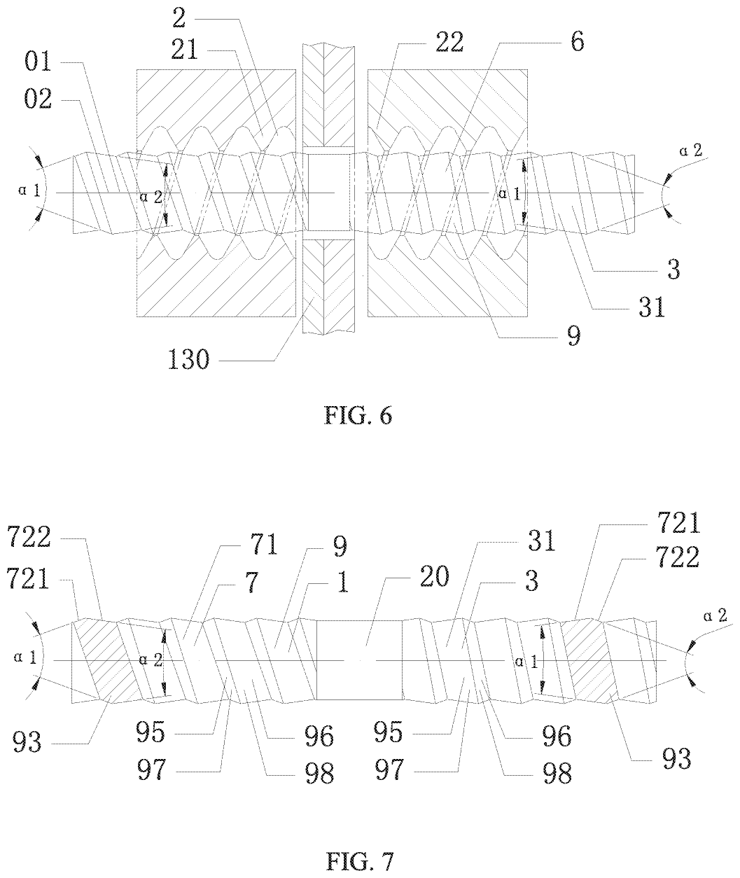

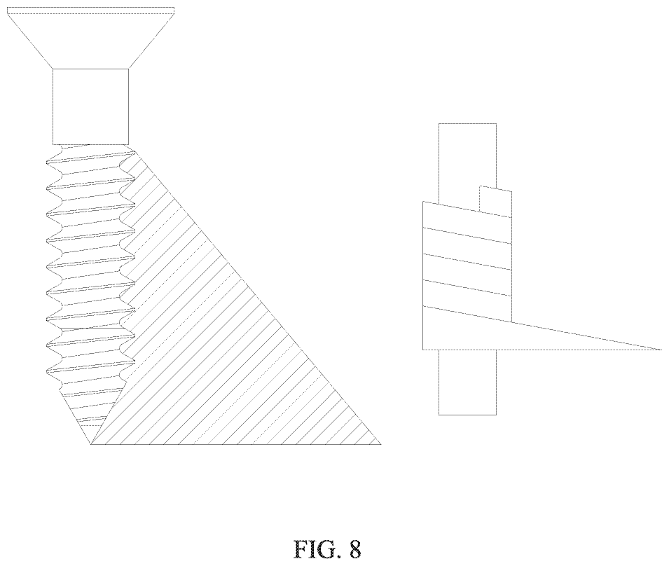

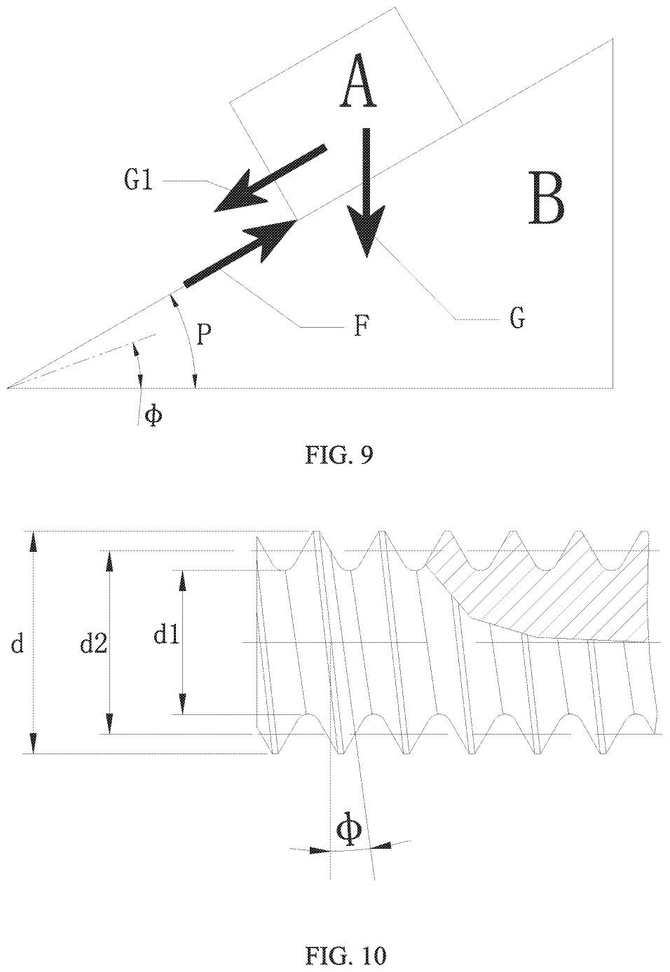

As shown in FIG. 6 and FIG. 7, the structure, principle and implementation steps of the present embodiment are similar to the first embodiment and the third embodiment, except that the screw body 31 on the cylindrical body 3 in the present embodiment includes screw thread structures of two asymmetrical bidirectional tapered threads 1 in olive-like shapes 93, that is, the asymmetrical bidirectional tapered thread 1 of a screw body 31 is an asymmetrical bidirectional tapered external thread 9 in an olive-like shape 93 with two taper structure forms in which a left taper 95 is less than a right taper 96 and the left taper 95 is greater than the right tape 96, wherein a thread section, which is located at the left side of a polish rod 20, that is, a non-thread section, of the screw body 31 is the asymmetrical bidirectional tapered external thread 9 in the olive-like shape 93 in which the left taper 95 is greater than the right tape 96, that is, a thread section, which is in mutual thread fit with a cylindrical body 2, that is, a nut body 21, located at the left side of a workpiece 130, of the external thread 9 is the asymmetrical bidirectional tapered external thread 9 in the olive-like shape 93 in which the left taper 95 is greater than the right tape 96; and a thread section, which is located at the right side of a polish rod 20, that is, a non-thread section, of the screw body 31 is the asymmetrical bidirectional tapered external thread 9 in the olive-like shape 93 in which the left taper 95 is less than the right tape 96, that is, a thread section, which is in mutual thread fit with a cylindrical body 2, that is, a nut body 22, located at the right side of a workpiece 130, of the external thread 9 is the asymmetrical bidirectional tapered external thread 9 in the olive-like shape 93 in which the left taper 95 is less than the right tape 96.

In the present embodiment, there are two structure forms, wherein a thread section at the left side of the polish rod 20, that is, the non-thread section, of the screw body 31 of the columnar body 3 is an asymmetrical bidirectional tapered external thread 9 in an olive-like shape 93 in which the left taper 95 is less than the right taper 96 and a thread section at the right side of the polish rod 20, that is, the non-thread section, of the screw body 31 is an asymmetrical bidirectional tapered external thread 9 in an olive-like shape 93 in which the left taper 95 is greater than the right taper 96. The structure, principle and implementation steps thereof are similar to the present embodiment.

The screw body 31 adopts which hybrid structure form of the asymmetrical bidirectional tapered external thread 9 in the olive-like shape 93 depending on the application requirement.

Specific embodiments described herein are exemplary illustrations to the spirit of the present invention. Those skilled in the art to which the present invention pertains may make various modifications or additions to the specific embodiments described or obtain equivalents by using similar alternatives without deviating from the spirit of the present invention or exceeding the scope defined by the appended claims.

Although terms such as tapered thread 1, cylindrical body 2, nut body 21, nut body 22, columnar body 3, screw body 21, polish rod 20, special tapered hole 4, special conical surface 42, traditional internal thread 6, truncated cone body, bidirectional truncated cone body 71, bidirectional conical surface 72 of truncated cone body, first helical conical surface 721 of truncated cone body, first taper angle α1, second helical conical surface 722 of truncated cone body, second taper angle α2, external helical line 8, bidirectional tapered external thread 9, olive-like shape 93, left taper 95, right taper 96, leftward distribution 97, rightward distribution 98, thread connection pair and/or thread pair 10, clearance 101, self-locking force, self-locking, self-positioning, pressure, cone axis 01, thread axis 02, mirror image, shaft sleeve, shaft, unidirectional tapered body, bidirectional tapered body, cone, internal cone, tapered hole, external cone, cone, cone pair, helical structure, helical movement, thread body, complete unit thread, axial force, axial force angle, counter-axial force, counter-axial force angle, centripetal force, counter-centripetal force, reverse collinear, internal stress, bidirectional force, unidirectional force, sliding bearing, sliding bearing pair, locking bearing surface 111, locking bearing surface 112, bearing surface 122 of tapered thread, bearing surface 121 of tapered thread, non-entity space, material entity, workpiece 130, locking direction of nut body, non-rigid connection, non-rigid material, transmission member, gasket and so on have been widely used in the present invention, other terms can be used alternatively. These terms are only used to better description and illustration of the essence of the present invention. It departs from the spirit of the present invention to deem it as any limitation of the present invention.

We claim:

1. A connection structure of an external thread of an asymmetrical bidirectional tapered thread in an olive-like shape and a traditional screw thread, comprising an internal thread (9) and an external thread (6) in mutual threaded fit, wherein
a complete unit thread of the symmetric bidirectional tapered external thread (9) in the olive-like shape (93) is a helical asymmetric bidirectional truncated cone body (71) in an olive-like shape (93), with a large middle and two small ends, and with different sizes in a left taper (95) and a right taper (96), and the complete unit thread comprises two taper structure forms in which the left taper (95) is greater than the right taper (96) and the left taper (95) is less than the right taper (96);
a thread body of the external thread (6) is a helical bidirectional tapered hole (4) in an internal surface of a cylindrical body (2) and exists in the form of a “non-entity space”, and the helical bidirectional tapered hole (4) is assimilated by making a tooth body of the traditional internal thread (6) be in cohesion contact with the bidirectional tapered external thread (9);
the left taper (95) formed by a left conical surface of the asymmetrical bidirectional tapered external thread (9) corresponds to a first taper angle (α1), and the right taper (96) formed by a right conical surface corresponds to a second taper angle (α2);
the left taper (95) and the right taper (96) are opposite in direction and different in taper size;
the internal thread (6) and the external thread (9) are in thread fit to house a cone in the tapered hole until an internal conical surface and an external conical surface mutually bear;
technical performances mainly depend on the conical surfaces and the taper sizes of the screw thread bodies in mutual fit;
the left taper (95) is greater than the right taper (96), preferably, the first taper angle (α1) is greater than 0° and less than 53°, and the second taper angle (α2) is greater than 0 and less than 53°; and for individual special fields, preferably, the first taper angle (α1) is greater than or equal to 53° and less than 180°; and
the left taper (95) is less than the right taper (96), preferably, the first taper angle (α1) is greater than 0° and less than 53°, and the second taper angle (α2) is greater than 0° and less than 53°; and for individual special fields, preferably, the second taper angle (α2) is greater than or equal to 53° and less than 180°.

2. The connection structure according to claim 1, wherein
the bidirectional tapered external thread (9) in the olive-like shape (93) comprises a left conical surface, that is, a first helical conical surface (721) of a truncated cone body, and a right conical surface, that is, a second helical conical surface (722) of the truncated cone body of a bidirectional conical surface (72) of the truncated cone body, and an external helical line (8);
a shape formed by the first helical conical surface (721) of the truncated cone body and the second helical conical surface (722) of the truncated cone body, that is, a bidirectional helical conical surface, is the same as a shape of an external helical lateral surface of a rotary body, wherein the rotary body is formed by two inclined sides of a right-angled trapezoid union when the right-angled trapezoid union axially moves at a constant speed along a central axis of the columnar body (3) while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the columnar body (3).

3. The connection structure according to claim 2, wherein when the right-angled trapezoid union makes one revolution at a constant speed, a distance that the right-angled trapezoid union axially moves is equal to at least double a length of the sum of right-angled sides of the two right-angled trapezoids.

4. The connection structure according to claim 2, wherein when the right-angled trapezoid union makes one revolution at a constant speed, a distance that the right-angled trapezoid union axially moves is equal to a length of the sum of right-angled sides of the two right-angled trapezoids.

5. The connection structure according to claim 1, wherein the left conical surface and the right conical surface, that is, the first helical conical surface (721) of the truncated cone body and the second helical conical surface (722) of the truncated cone body, and the external helical line (8) of the asymmetric bidirectional tapered body (9) are both continuous helical surfaces or non-continuous helical surfaces; and the special tapered hole (4) has a special conical surface (42), and the special conical surface (42) is a continuous helical surface or a non-continuous helical surface.

6. The connection structure according to claim 1, wherein the external thread (9) is formed by symmetrically and oppositely joining lower bottom surfaces of two truncated cone bodies (7) with the same lower bottom surfaces and the upper top surfaces but different taper heights; and
upper top surfaces are disposed on two ends of the bidirectional truncated cone bodies (71) to form the asymmetric bidirectional tapered thread (1) in the olive-like shape (93), the process comprises that the upper top surfaces are respectively jointed with the upper top surfaces of the adjacent bidirectional truncated cone bodies 71 and/or respectively jointed with the upper top surfaces of the adjacent bidirectional truncated cone bodies 71 in a helical form so as to form the asymmetric bidirectional tapered external thread (9) in the olive-like shape (93).

7. The connection structure according to claim 1, wherein a traditional screw thread comprises any one of a triangular thread, a trapezoidal thread, a sawtooth thread, a rectangular thread and an arc thread, but is not limited to the above threads, may be any applicable threads and comprises the traditional screw thread with a thread body, that is, a tooth body subjected to deformation capable of conforming to the technical spirit of the present invention only when the thread body is in mutual thread fit with the bidirectional tapered internal thread (6).

8. The connection structure according to claim 1, wherein
the bidirectional tapered external thread (9) has a capability of assimilating a traditional internal thread (6) and comprises that a single-pitch thread body is an incomplete tapered geometry, that is, the single-pitch thread body is an incomplete unit thread;
a traditional internal thread (6) assimilated by the bidirectional tapered external thread (9) is a dissimilated traditional screw thread, that is, a thread body of the dissimilated traditional screw thread is a special tapered thread (1), the internal thread (6) and the external thread (9) form a thread pair (10) in such a way that the helical bidirectional tapered hole (71) and the special helical tapered body (7) are mutually cooperated to form a cone pair with multiple pitches; and
the special conical surface (42) and the first helical conical surface (721) and the second helical conical surface (722) of the truncated cone body achieve that internal and external diameters of an internal cone and an external cone are centralized by taking a contact surface as a bearing surface under the guidance of the helical line until the bidirectional conical surface (72) of the truncated cone body and the special conical surfaces (42) are cohered to achieve load bearing in one direction of the helical conical surface and/or the simultaneous load bearing in both directions of the helical conical surface and/or until the sizing self-positioning contact and/or until the sizing interference contact to achieve self-locking.

9. The connection structure according to claim 1, wherein
the columnar body (3) can be solid or hollow, and comprises columnar workpieces and objects and/or non-columnar workpieces and objects that need to be machined with screw threads on their external surfaces, the external surfaces comprise columnar surfaces, non-columnar surfaces such as conical surfaces, and internal surfaces of other geometric shapes;
when a screw body (31) of the columnar body (3) is provided with one and/or two asymmetric bidirectional tapered threads (1) in olive-like shapes (93) comprising an asymmetric bidirectional tapered external thread (9) in an olive-like shape (93) in which a left taper (95) is greater than a right taper (96) and/or an asymmetric bidirectional tapered external thread (9) in an olive-like shape (93) in which the left taper (95) is less than the right taper (96); and
when one cylindrical body (2) has been effectively combined with the columnar body (3), that is, the internal thread (6) and the external thread (9) forming the tapered thread connection pair (10) are effectively are effectively cohered together, the other cylindrical body (2) can be removed and/or retained, the removed cylindrical body (2) is used as a mounting process nut, an internal thread of the removed cylindrical body (2) comprises the traditional screw thread (1) and can be further produced from a unidirectional tapered thread and a bidirectional tapered thread capable of engaging with the screw thread of the columnar body (3).

10. The connection structure according to claim 1, wherein the external thread (9) comprises that a single-pitch thread body is an incomplete tapered geometry, that is, the single-pitch thread body is an incomplete unit thread.
